(19) United States
(12) Patent Application Publication
(10) Pub. No.: US 2015/0319526 A1
(43) Pub. Date: Nov. 5, 2015

(54) BONE CONDUCTION SPEAKER AND BONE CONDUCTION HEADPHONE DEVICE

(71) Applicant: Panasonic Intellectual Property Management Co., Ltd., Osaka (JP)

(72) Inventors: Hiroshi KUNIMOTO, Osaka (JP); Yushi OGINO, Hyogo (JP)

(21) Appl. No.: 14/796,886

(22) Filed: Jul. 10, 2015

Related U.S. Application Data
(63) Continuation of application No. PCT/JP2014/004662, filed on Sep. 10, 2014.

(30) Foreign Application Priority Data
Sep. 20, 2013 (JP) 2013-194917

(51) Int. Cl. H04R 3/00; H04R 1/10

(52) U.S. Cl. CPC H04R 3/00; H04R 1/1091; H04R 2460/13

(57) ABSTRACT

A bone conduction speaker includes a vibration driver configured to generate mechanical vibrations and air vibrations from an audio signal, a first elastic member configured to cover a portion of the vibration driver to form a space, and convert the air vibrations emitted by the vibration driver into the space, into mechanical vibrations, a second elastic member configured to be in contact with the vibration driver, and transfer the mechanical vibrations generated by the vibration driver and the mechanical vibrations received from the first elastic member, to a user, and an adjustment screw configured to act on the first elastic member to adjust at least one of the volume of the space and the distance between vibration nodes of the first elastic member.

### CROSS-REFERENCE TO RELATED APPLICATIONS

This is a continuation of International Application No. PCT/JP2014/004662 filed on Sep. 10, 2014, which claims priority to Japanese Patent Application No. 2013-194917 filed on Sep. 20, 2013. The entire disclosures of these applications are incorporated by reference herein.

### BACKGROUND

The present disclosure relates to bone conduction speakers and bone conduction headphone devices.

Japanese Unexamined Patent Publication No. 2011-130334 describes a bone conduction speaker and bone conduction headphone device that include a main vibration output unit that is made contact with a side surface of the user's head and is used to output mechanical vibrations to the user's skull, and an auxiliary vibration output unit that is made contact with the user's tragus and is used to output mechanical vibrations to the cartilage of the tragus. The user can hear deep bass without putting the device in or over their ears.

### SUMMARY

The present disclosure describes implementations of a bone conduction speaker and bone conduction headphone device that have adjustable vibration-frequency characteristics.

An example bone conduction speaker and bone conduction headphone device according to the present disclosure includes a vibration driver configured to generate mechanical vibrations and air vibrations from an audio signal, a first elastic member configured to cover a portion of the vibration driver to form a space, and convert the air vibrations emitted by the vibration driver into the space, into mechanical vibrations, a second elastic member configured to be in contact with the vibration driver, and transfer the mechanical vibrations generated by the vibration driver and the mechanical vibrations received from the first elastic member, to a user, and an adjustment unit configured to act on the first elastic member to adjust at least one of a volume of the space and a distance between vibration nodes of the first elastic member.

In the example bone conduction speaker and bone conduction headphone device of the present disclosure, vibration-frequency characteristics can be adjusted by changing at least one of the space formed by covering a portion of the vibration driver with the first elastic member and the distance between vibration nodes of the first elastic member.

### BRIEF DESCRIPTION OF THE DRAWINGS

FIG. 1 is a perspective view showing a basic configuration of an example bone conduction headphone device according to the present disclosure.

FIG. 2 is an exploded perspective view showing an internal configuration of the bone conduction speaker of FIG. 1.

FIG. 3 is an enlarged cross-sectional view showing a detailed configuration of a vibration driver shown in FIG. 2.

FIG. 4 is a cross-sectional view showing an internal configuration of the bone conduction speaker of FIG. 1.

FIG. 5 is a diagram showing the bone conduction headphone device of FIG. 1 that is in use.

FIG. 6 is a diagram for describing operation of the bone conduction speaker of FIG. 1.

FIGS. 7A and 7B are cross-sectional views showing two internal states of a bone conduction speaker according to a first embodiment.

FIG. 8 is a diagram showing output vibration power-vs-frequency characteristics of the bone conduction speaker of the first embodiment in the two internal states.

FIGS. 9A and 9B are cross-sectional views showing two internal states of a bone conduction speaker according to a second embodiment.

FIG. 10 is a diagram showing output vibration power-vs-frequency characteristics of the bone conduction speaker of the second embodiment in the two internal states.

FIGS. 11A, 11B, and 11C are cross-sectional views showing three internal states of a bone conduction speaker according to a third embodiment.

FIG. 12 is a cross-sectional view showing one of internal states of a bone conduction speaker according to a fourth embodiment.

FIG. 13 is a block diagram showing a circuit configuration of a bone conduction headphone device including the bone conduction speaker of FIG. 12.

### DETAILED DESCRIPTION

Embodiments will now be described in detail with reference to the accompanying drawings. To avoid unnecessarily obscuring the present disclosure, well-known features may not be described or substantially the same elements may not be redundantly described, for example. This is for ease of understanding.

The drawings and the following description are provided to enable those skilled in the art to fully understand the present disclosure and are in no way intended to limit the scope of the present disclosure as set forth in the appended claims.

### Basic Configuration

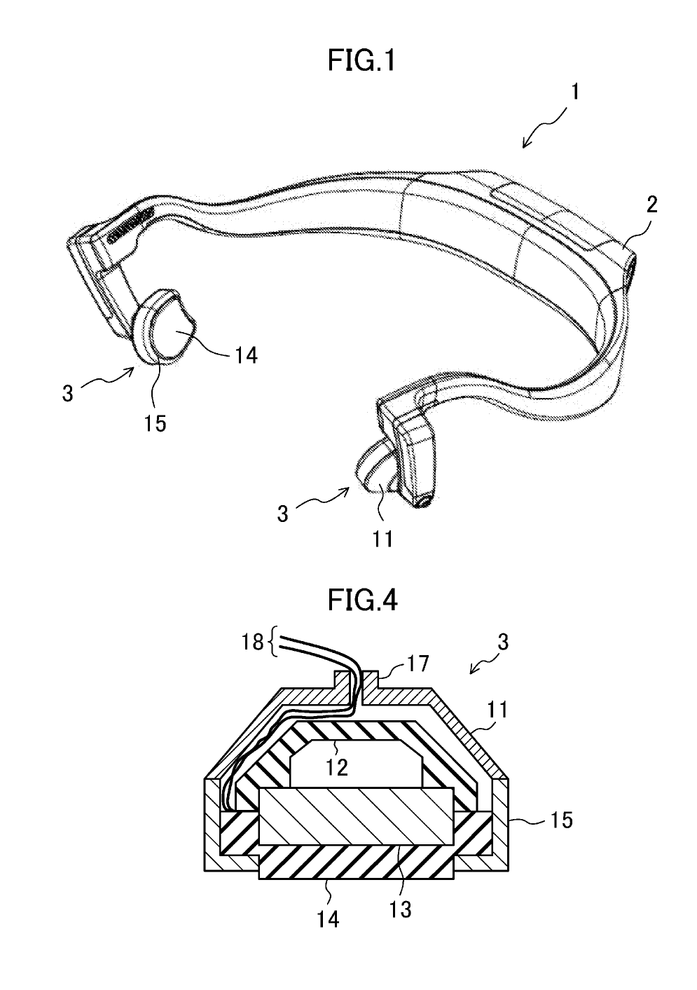

Firstly, basic configurations of an example bone conduction headphone device and bone conduction speaker according to the present disclosure will be described with reference to FIGS. 1-6.

### 1-1. Configuration

### 1-1-1. Configuration of Bone Conduction Headphone Device

FIG. 1 is a perspective view showing a basic configuration of an example bone conduction headphone device according to the present disclosure. The bone conduction headphone device 1 of FIG. 1 includes a band 2, and bone conduction speakers 3 provided at opposite ends of the band 2 (one speaker for each end). The band 2 is formed of a suitably elastic material, such as a synthetic resin (polypropylene, etc.) or a metal (aluminum, stainless steel, etc.), and in a generally U-shape, so that the user can wear the bone conduction headphone device 1 around the back of their head or neck.

### 1-1-2. Configuration of Bone Conduction Speaker

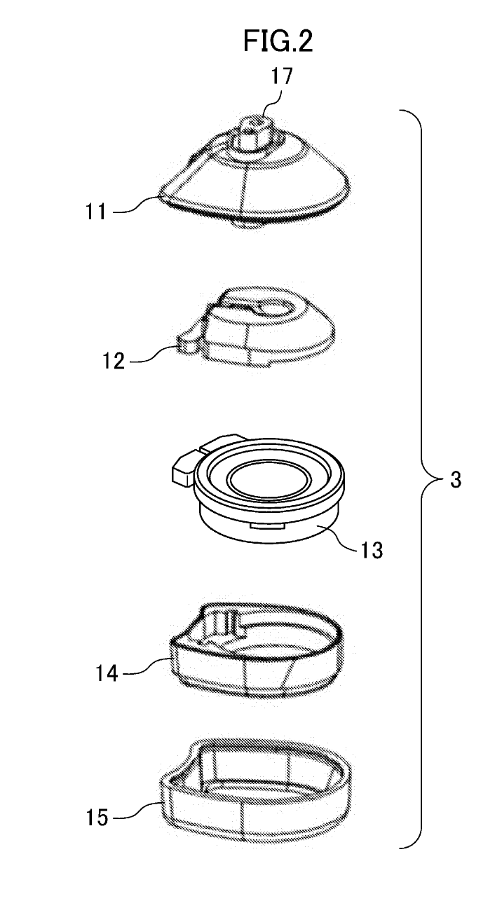

FIG. 2 is an exploded perspective view showing an internal configuration of the bone conduction speaker 3 of FIG. 1. In the bone conduction speaker 3, a vibration driver 13 is enclosed by a first elastic member 12 and a second elastic member 14, the resultant structure is contained in a first housing 15, and the first housing 15 is covered by a second housing 11 having a hole 17 through which a signal line (not shown) is passed. As shown in FIG. 1, the second elastic member 14 is exposed through an opening of the first housing 15, and can be made contact with a side surface of the user's head.

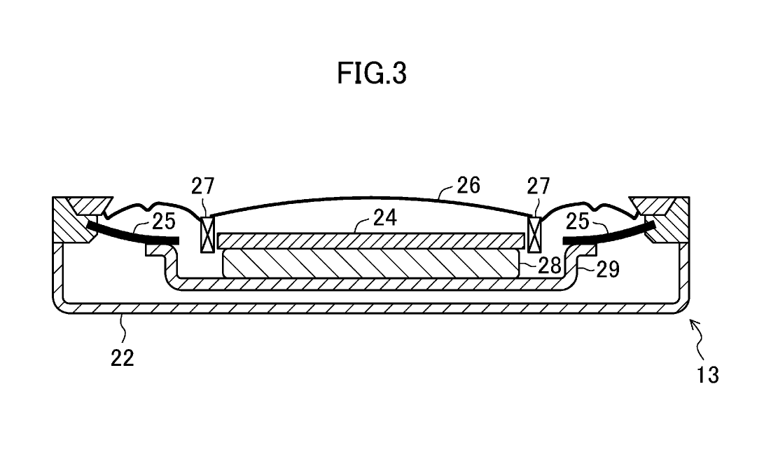

FIG. 3 is an enlarged cross-sectional view showing a detailed configuration of the vibration driver 13 of FIG. 2. The vibration driver 13 is of the electromagnetic type that converts an audio signal into mechanical vibrations. The vibration driver 13 includes a coil 27 through which an audio signal received through a signal line (not shown) is passed, a magnet 24 that vibrates up and down according to changes in magnetic field caused by the coil 27, a weight 28 that adds a weight to the magnet 24, a yoke 29 that is joined with the weight 28, a spring 25 that holds the magnet 24 and the weight 28 through the yoke 29, a diaphragm 26 that vibrates up and down together with the coil 27 due to the magnetic action of the coil 27 on the magnet 24, and a housing 22 that houses the magnet 24, the spring 25, the diaphragm 26, the coil 27, the weight 28, and the yoke 29. The mechanical vibrations of the magnet 24 are output through the spring 25 and the housing 22. The weight 28 and the yoke 29 as well as the magnet 24 are formed of, for example, electromagnetic soft iron.

FIG. 4 is a cross-sectional view showing an internal configuration of the bone conduction speaker 3 of FIG. 1. The first housing 15 and the second housing 11 are formed of, for example, a synthetic resin, etc. The second housing 11 has the hole 17 through which two signal lines 18 provided in the band 2 lead into the second housing 11. The signal lines 18 are connected to the vibration driver 13.

The first elastic member 12 covers one surface of the vibration driver 13 to form a space, and is arranged in contact with the second elastic member 14. The first elastic member 12 is formed of a material that is suitably elastic, such as rubber, etc. A side surface of the first elastic member 12 may be in contact with the second housing 11.

The second elastic member 14 is arranged in contact with a bottom portion of the vibration driver 13, and is exposed through the opening of the first housing 15. The second elastic member 14 is formed of a material that is suitably elastic, such as rubber, etc. Although, in the bone conduction speaker 3 of FIG. 4, a side surface of the second elastic member 14 is in contact with the first housing 15, there may be a gap between the side surface of the second elastic member 14 and the first housing 15.

### 1-2. Operation

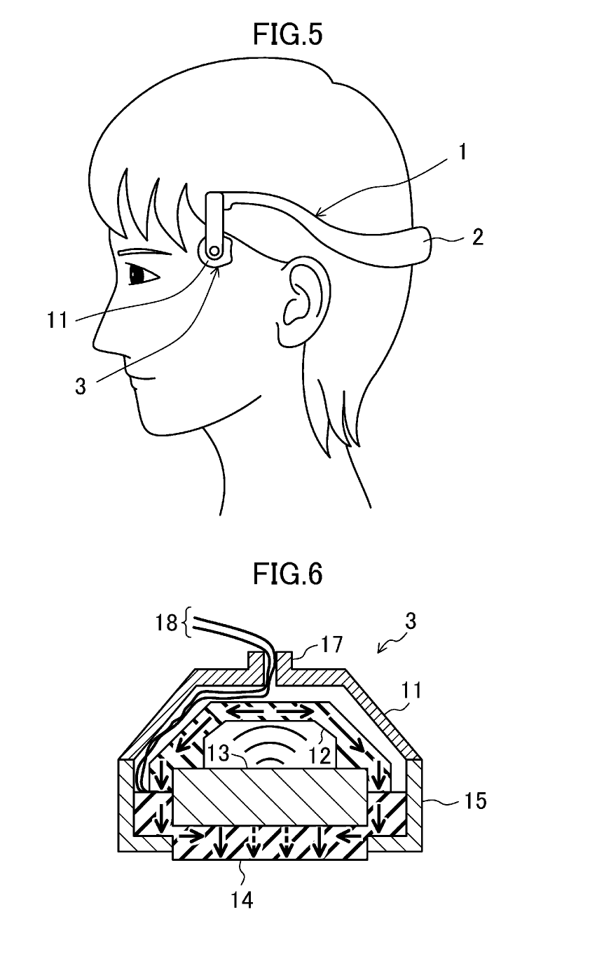

FIG. 5 is a diagram showing the bone conduction headphone device 1 of FIG. 1 that is in use. The user wears the bone conduction headphone device 1 while the bone conduction speakers 3 are in contact with side surfaces of the head.

FIG. 6 is a diagram for describing operation of the bone conduction speaker 3. In FIG. 3, when an audio signal is passed through the coil 27, the magnet 24 vibrates up and down together with the weight 28 and the yoke 29. The diaphragm 26 vibrates up and down together with the coil 27 with respect to the magnet 24. Thus, the vibration driver 13 converts an input audio signal into mechanical vibrations. The second elastic member 14 transfers the mechanical vibrations of the vibration driver 13 to the user. On the other hand, the vibrations of the vibration driver 13 generate air vibrations in the space formed between the vibration driver 13 and the first elastic member 12. The air vibrations are converted by the first elastic member 12 into mechanical vibrations, which are then transferred to the second elastic member 14. The second elastic member 14 also transfers the mechanical vibrations received from the first elastic member 12 to the user.

According to the basic configurations of the bone conduction headphone device 1 and the bone conduction speaker 3 of the present disclosure, not only the mechanical vibrations of the vibration driver 13 are transferred to the user through the second elastic member 14, but also the air vibrations of the space formed between the vibration driver 13 and the first elastic member 12 are converted by the first elastic member 12 into mechanical vibrations, which are then transferred to the user through the second elastic member 14. Therefore, vibrations can be output with high efficiency.

Note that, in order to reduce or prevent sound leakage caused by vibrations of the signal lines 18, the signal lines 18 may be sandwiched by the first elastic member 12 and the second elastic member 14 as shown in FIGS. 4 and 6.

First to fourth embodiments related to adjustment of vibration-frequency characteristics that is a feature of the present disclosure will now be described.

### First Embodiment

### 2-1. Configuration

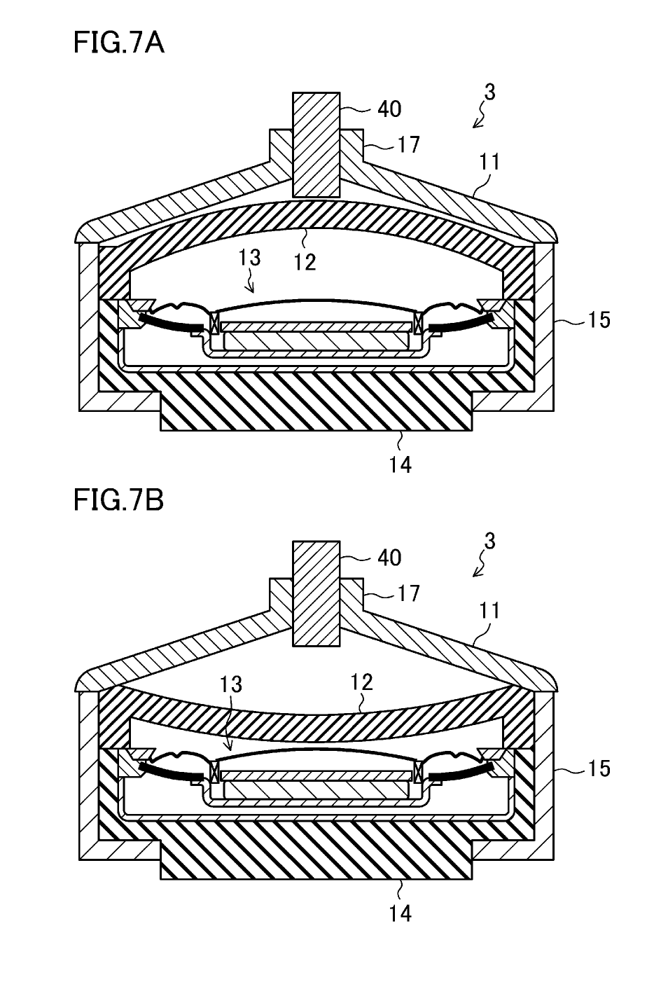

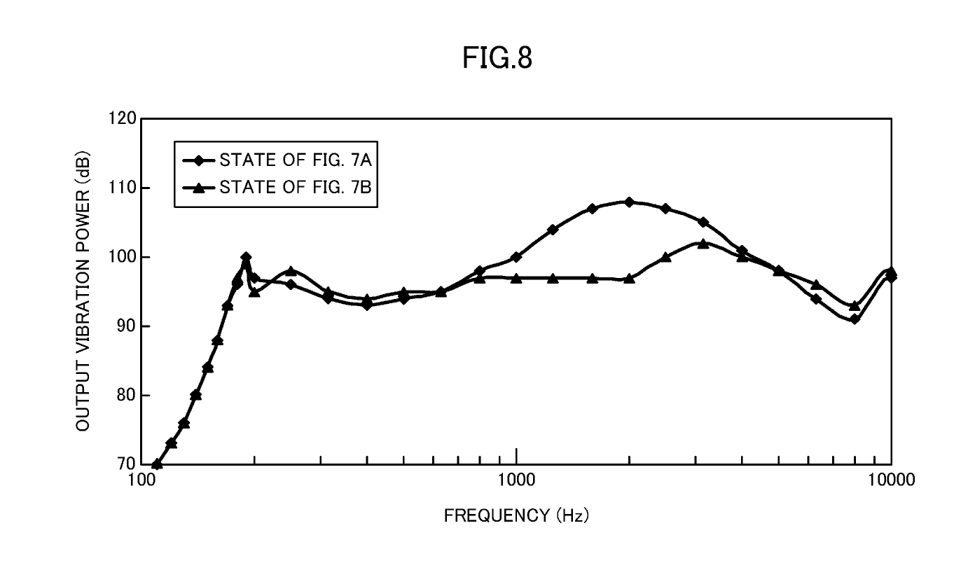

FIGS. 7A and 7B are cross-sectional views showing two internal states of the bone conduction speaker 3 of the first embodiment. In the first embodiment, a push switch 40 is provided that penetrates through the hole 17 of the second housing 11. The push switch 40 is used to deform the first elastic member 12 so that the volume of a vibration space between the first elastic member 12 and the vibration driver 13 is changed.

### 2-2. Operation

In FIG. 7A, the first elastic member 12 has a dome shape, and the volume of the vibration space between the first elastic member 12 and the vibration driver 13 is, for example, 0.3 cm³. On the other hand, in FIG. 7B, the first elastic member 12 has a flat shape, and the volume of the vibration space is, for example, 0.1 cm³. Thus, the volume of the vibration space is smaller in FIG. 7B than in FIG. 7A.

When the push switch 40 is pushed in the state of FIG. 7A, the state of FIG. 7A is changed to the state of FIG. 7B. When the push switch 40 is pushed again, the state of FIG. 7B is changed to the state of FIG. 7A in reaction to the push.

### 2-3. Advantages, etc.

FIG. 8 is a diagram showing output vibration power-vs-frequency characteristics (hereinafter also referred to as “vibration-frequency characteristics”) of the bone conduction speaker 3 of the first embodiment in the two internal states. In FIG. 8, the vertical axis represents output vibration powers (dB), and the horizontal axis represents frequencies (Hz).

In the example of FIG. 8, the resonant frequency is about 2 kHz in the state of FIG. 7A and about 3.1 kHz in the state of FIG. 7B. In other words, the resonant frequency is higher in the state of FIG. 7B than in the state of FIG. 7A. Thus, by changing the volume of the vibration space between the first elastic member 12 and the vibration driver 13, the vibration-frequency characteristics of the bone conduction speaker 3 can be adjusted.

For example, for learning language, vibration-frequency characteristics in which the vibration power is emphasized at frequencies of 500 Hz to 2 kHz are preferable because such vibration-frequency characteristics allow the user to clearly hear human voices. On the other hand, for listening to music, vibration-frequency characteristics in which the vibration power is flat within the wide range of 200 Hz to 10 kHz, i.e., is extended to a high frequency region, are preferable. Therefore, the user may operate the push switch 40 to set the bone conduction speaker 3 to the internal state of FIG. 7A for learning language or to the internal state of FIG. 7B for listening to music.

### Second Embodiment

### 3-1. Configuration

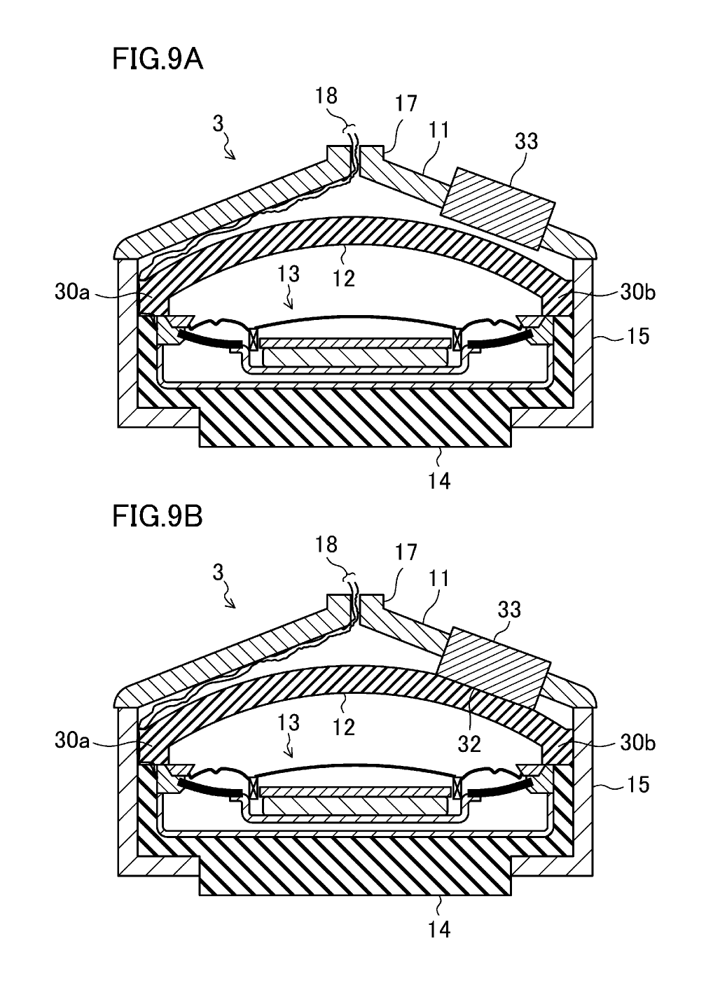

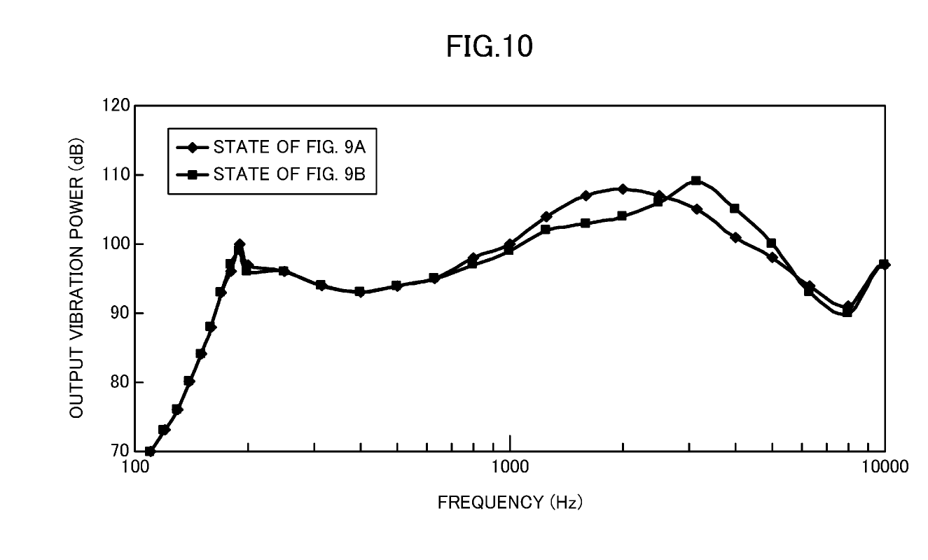

FIGS. 9A and 9B are cross-sectional views showing two internal states of a bone conduction speaker 3 according to a second embodiment. In the second embodiment, a push switch 33 is provided that penetrates through a portion of the second housing 11 that is located in the vicinity of an outer periphery thereof. The distance between vibration nodes of the first elastic member 12 is changed, depending on whether the push switch 33 is away from or in contact with the first elastic member 12.

### 3-2. Operation

In FIG. 9A, the push switch 33 is off, i.e., the push switch 33 is away from the first elastic member 12, and therefore, the distance between vibration nodes 30a and 30b along the first elastic member 12 is long, e.g., 23 mm On the other hand, in FIG. 9B, the push switch 33 is on, i.e., the push switch 33 is in contact with the first elastic member 12, so that an additional vibration node 32 is formed, and therefore, the distance between the vibration nodes 30a and 32 along the first elastic member 12 is short, e.g., 16 mm.

### 3-3. Advantages, etc.

FIG. 10 is a diagram showing output vibration power-vs-frequency characteristics (hereinafter also referred to as “vibration-frequency characteristics”) of the bone conduction speaker 3 of the second embodiment in the two internal states. In FIG. 10, the vertical axis represents output vibration powers (dB), and the horizontal axis represents frequencies (Hz).

In the example of FIG. 10, the resonant frequency is about 2 kHz in the state of FIG. 9A and about 3.1 kHz in the state of FIG. 9B. In other words, the resonant frequency is higher in the state of FIG. 9B than in the state of FIG. 9A. Thus, by changing the distance between vibration nodes of the first elastic member 12, the vibration-frequency characteristics of the bone conduction speaker 3 can be adjusted.

For example, the user may turn the push switch 33 on to set the bone conduction speaker 3 to the internal state of FIG. 9A for learning language or off to set the bone conduction speaker 3 to the internal state of FIG. 9B for listening to music.

Note that a plurality of push switches 33 (e.g., four push switches 33) may be provided with respect to the first elastic member 12.

### Third Embodiment

### 4-1. Configuration

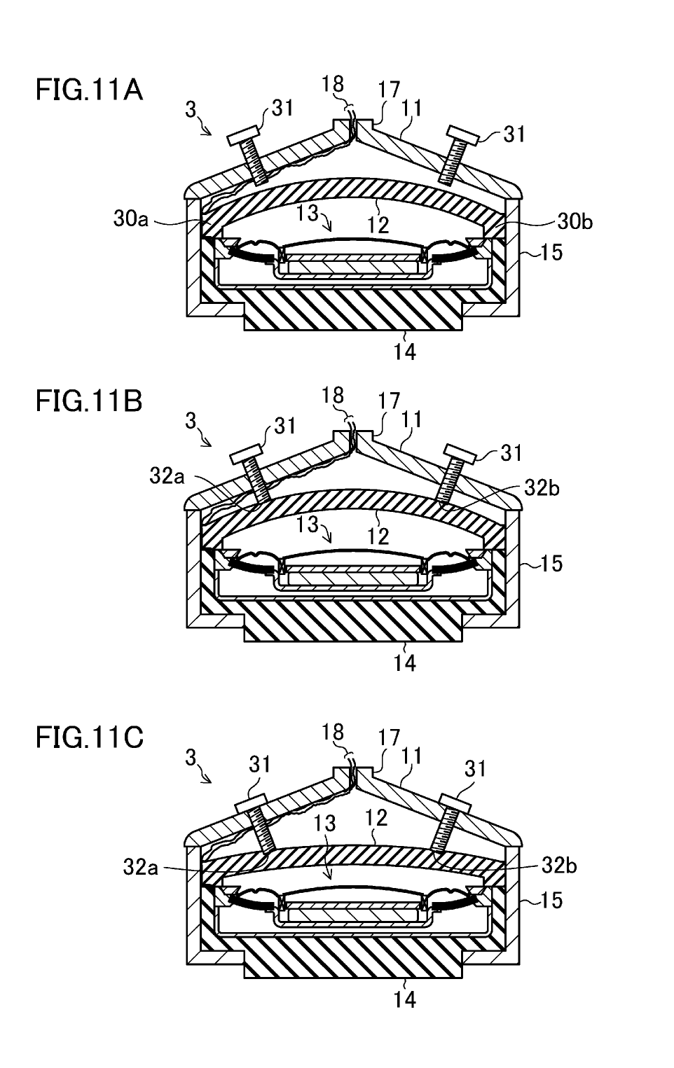

FIGS. 11A, 11B, and 11C are cross-sectional views showing three internal states of a bone conduction speaker 3 according to a third embodiment. In the third embodiment, four adjustment screws 31 are provided that penetrate through respective portions of the second housing 11 that are located in the vicinity of an outer periphery thereof. The distance between vibration nodes of the first elastic member 12 is changed, depending on whether the adjustment screws 31 are away from or in contact with the first elastic member 12. The adjustment screws 31 are used to deform the first elastic member 12 and thereby change the volume of the vibration space between the first elastic member 12 and the vibration driver 13.

### 4-2. Operation

In FIG. 11A, the adjustment screws 31 are away from the first elastic member 12, and therefore, the distance between the vibration nodes 30a and 30b along the dome-shaped first elastic member 12 is long. On the other hand, in FIG. 11B, the adjustment screws 31 are slightly moved down to be in contact with the first elastic member 12, so that additional vibration nodes 32a and 32b are formed. Therefore, the distance between the vibration nodes 32a and 32b along the first elastic member 12 is short. Note that, in FIG. 11B, the first elastic member 12 remains in the dome shape. In FIG. 11C, the adjustment screws 31 are further moved down so that the first elastic member 12 is changed to a flat shape while the short distance between the vibration nodes 32a and 32b along the first elastic member 12 is maintained.

### 4-3. Advantages, etc.

As can be seen by analogy with FIGS. 8 and 10, the resonant frequency is higher in the state of FIG. 11B than in the state of FIG. 11A, and the resonant frequency is higher in the state of FIG. 11C than in the state of FIG. 11B. Thus, the vibration-frequency characteristics of the bone conduction speaker 3 can be adjusted by changing the distance between vibration nodes of the first elastic member 12 or changing the volume of the vibration space between the first elastic member 12 and the vibration driver 13.

For example, the user may set the adjustment screws 31 to the state of FIG. 11A for learning language or the state of FIG. 11B or 11C for listening to music.

### Fourth Embodiment

### 5-1. Configuration

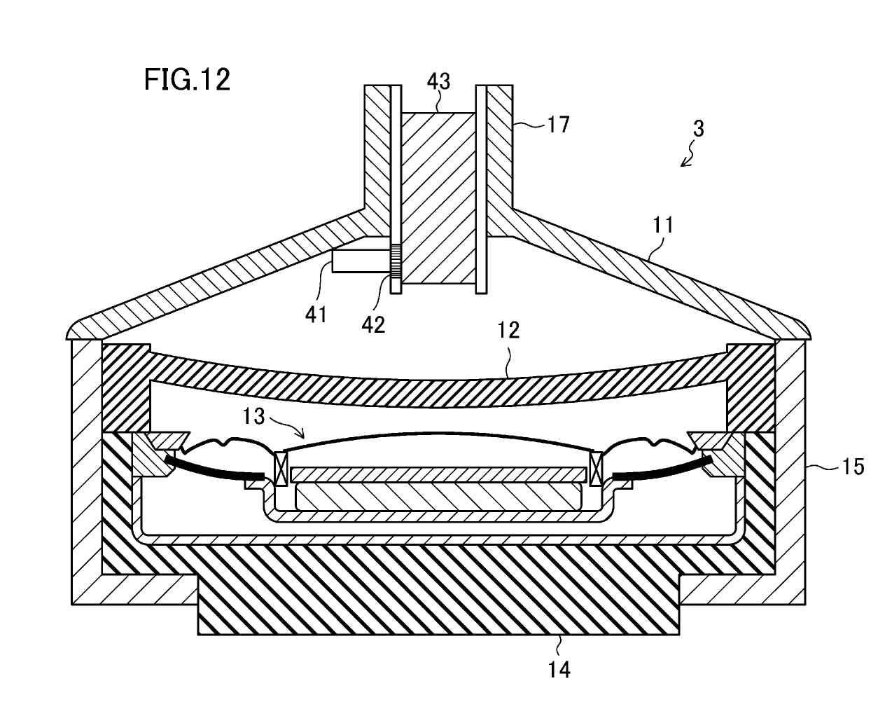

FIG. 12 is a cross-sectional view showing one of internal states of a bone conduction speaker 3 according to a fourth embodiment. In the fourth embodiment, a movable member 43 is inserted into the hole 17 of the second housing 11. A motor 41 and a gear 42 that are used to move the movable member 43 up and down are fixed to an upper inner portion of the second housing 11. The movable member 43 is automatically moved up and down by the motor 41 and the gear 42 without the user's operation, to mechanically act on the first elastic member 12 and thereby deform the first elastic member 12. As a result, as in the first embodiment, the volume of the vibration space between the first elastic member 12 and the vibration driver 13 is changed.

Specifically, when the movable member 43 is moved up in the state of FIG. 12, the first elastic member 12 is changed to a dome shape in reaction to the upward movement, so that the volume of the vibration space between the first elastic member 12 and the vibration driver 13 increases. When the vibration space is large, then if the movable member 43 is moved down again, the state of FIG. 12 can be obtained.

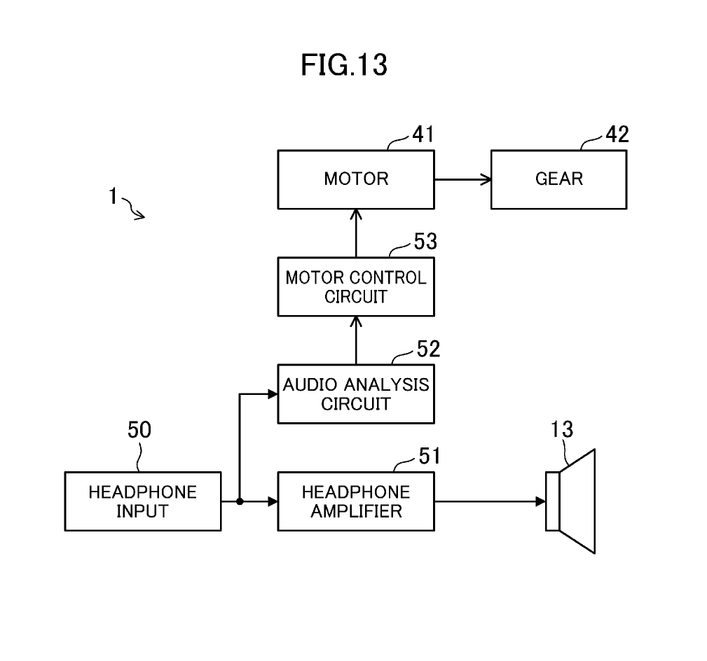

FIG. 13 is a block diagram showing a circuit configuration of a bone conduction headphone device 1 including the bone conduction speaker 3 of FIG. 12. The circuit of FIG. 13 includes a headphone input 50, a headphone amplifier 51 connected to the vibration driver 13, an audio analysis circuit 52, and a motor control circuit 53 connected to the motor 41.

### 5-2. Operation

For example, the audio analysis circuit 52 determines that the internal state for learning language is suitable if the power of an audio signal component of 10 kHz is less than the threshold, and that an internal state for listening to music is suitable if the power of an audio signal component of 10 kHz is not less than the threshold. Based on the result of the determination, the motor control circuit 53 drives the motor 41 so that the volume of the vibration space is increased for learning language or decreased for listening to music. In other words, in the circuit of FIG. 13, the audio analysis circuit 52 determines the type of an input audio based on the headphone input 50, and the motor control circuit 53 drives the motor 41 so that vibration-frequency characteristics suitable for the determination result are obtained.

### 5-3. Advantages, etc.

According to the fourth embodiment, the vibration-frequency characteristics of the bone conduction speaker 3 and the bone conduction headphone device 1 can be automatically adjusted.

Note that when the bone conduction headphone device 1 receives digital audio data, the type of the input audio may be determined based on title information contained in the data.

### Other Embodiments

In the foregoing description, the first to fourth embodiments of the technology disclosed herein have been illustrated. The present disclosure is not limited to these embodiments. The present disclosure is applicable to the embodiments to which changes, replacements, additions, deletions, etc., have been made. Parts of the first to fourth embodiments may be combined to obtain other new embodiments.

The first elastic member 12 and the second elastic member 14 are not limited to rubber, and alternatively, may be formed of, for example, polystyrene foam, etc. Also, the volume of the vibration space between the first elastic member 12 and the vibration driver 13 may be changed by thermally deforming the first elastic member 12.

Although, in the above example, the bone conduction speaker 3 and the bone conduction headphone device 1 are switched between two sets of vibration-frequency characteristics for learning language and listening to music, the bone conduction speaker 3 and the bone conduction headphone device 1 may be switched between three or more sets of vibration-frequency characteristics.

Although, in the bone conduction headphone device 1, the bone conduction speaker 3 is provided at each of the opposite ends of the band 2, the bone conduction speaker 3 may be provided at only one end of the band 2. When the bone conduction speaker 3 is provided at only one end, a pad may be provided at the other end instead of the bone conduction speaker 3, for example. The band 2 may be configured to be wrapped around the user's head. The bone conduction headphone device 1 may not include the band 2, and may be an ear-fitting headphone device, etc.

Although, in the foregoing, the vibration driver 13 is of the electromagnetic type, the vibration driver 13 may be of various types, such as electrodynamic, electrostatic, piezoelectric, etc.

As described above, embodiments of the technology disclosed herein have been illustrated. To do so, the accompanying drawings and the detailed description have been provided.

Therefore, the components described in the drawings and the detailed description may include not only components essential for achieving the present disclosure, but also non-essential components that are used to illustrate the above technology. Therefore, the non-essential components should not be immediately considered as being essential because those components are described in the drawings and the detailed description.

The above embodiments are for the purpose of illustration of the technology of the present disclosure, and therefore, various changes, replacements, additions, deletions, etc., can be made thereto within the scope of the claims or equivalents thereof.

The present disclosure is applicable to bone conduction speakers and bone conduction headphone devices that have adjustable vibration-frequency characteristics. Specifically, the present disclosure is applicable to mobile telephones, smartphones, etc., that can play back music.

What is claimed is:

1. A bone conduction speaker comprising:
a vibration driver configured to generate mechanical vibrations and air vibrations from an audio signal;
a first elastic member configured to cover a portion of the vibration driver to form a space, and convert the air vibrations emitted by the vibration driver into the space, into mechanical vibrations;
a second elastic member configured to be in contact with the vibration driver, and transfer the mechanical vibrations generated by the vibration driver and the mechanical vibrations received from the first elastic member, to a user; and
an adjustment unit configured to act on the first elastic member to adjust at least one of a volume of the space and a distance between vibration nodes of the first elastic member.

2. The bone conduction speaker of claim 1, wherein
the vibration driver includes
a coil configured to conduct the audio signal;
a magnet configured to generate the mechanical vibrations in reaction to the coil, and
a diaphragm configured to vibrate together with the coil in reaction to the magnet to generate the air vibrations.

3. The bone conduction speaker of claim 1, wherein
the first elastic member is in contact with the second elastic member, and
the first elastic member and the second elastic member surround the vibration driver.

4. A bone conduction headphone device comprising:
a band; and
the bone conduction speaker of claim 1 provided at at least one end of the band.

5. The bone conduction headphone device of claim 4, further comprising:
a unit configured to determine an input audio type based on a headphone input, and drive the adjustment unit to obtain vibration-frequency characteristics suitable for the result of the determination.
